(19) United States
(12) Patent Application Publication
(10) Pub. No.: US 2003/0137545 A1
(43) Pub. Date: Jul. 24, 2003

(54) Method for displaying photo pages on the internet

(75) Inventors: Thomas J. Hoehn, Rochester, NY (US); Matthew H. Bernius, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Copmany

(21) Appl. No.: 10/051,427

(22) Filed: Jan. 18, 2002

(51) Int. Cl. G09G 5/00

(52) U.S. Cl. 345/838

(57) ABSTRACT

A method for displaying photo pages on the Internet, the method comprises the steps of displaying a template having a plurality of page layouts on the Internet; displaying a template having a plurality of styles for the page layouts on the Internet; after selection by a user of the page layout and style, displaying the selected combination of the page layout and style for forming a selected photo page on the Internet; and inserting one or more images that are selected by the user into the selected photo page.

### CROSS-REFERENCE TO RELATED APPLICATIONS

The present application is related to U.S. application Ser. No. 09/966,314, filed Sep. 28, 2001, by Matthew H. Bernius and Thomas J. Hoehn, and entitled, “A Discussion Board of a Website Having Images”; U.S. application Ser. No. 09/944,551, filed Aug. 31, 2001, by Matthew H. Bernius and Thomas J. Hoehn, and entitled, “A Website Chat Room Having Images Displayed Simultaneously With Interactive Chatting”; and U.S. application Ser. No. 09/907,868, filed Jul. 18, 2001, by Matthew H. Bernius and Thomas J. Hoehn, and entitled, “A Website Having Images As A Navigational Tool For User-Created Photopages On The Internet.”

### FIELD OF THE INVENTION

The invention relates generally to the field of displaying images on the Internet and, more particularly, to displaying such images on the Internet in a user-friendly and efficient manner.

### BACKGROUND OF THE INVENTION

Currently known and utilized websites include web pages having images for visually enhancing the appearance of the web pages. The images are installed upon creation of the web pages by highly skilled web designers and are not modifiable by subsequent visitors of the web pages.

Although the currently known and utilized web pages are satisfactory, they include drawbacks. Typical users of the Internet are not skilled enough to include images on web pages in an aesthetically pleasing manner. Such web images would typically require layout design, resizing and the like which tasks typical users are not capable of performing.

Consequently, a need exists for user-friendly internet based web page creation tool in which typical users can include images in an aesthetically pleasing way.

### SUMMARY OF THE INVENTION

The present invention is directed to overcoming one or more of the problems set forth above. Briefly summarized, according to one aspect of the present invention, the invention resides in a method for displaying photo pages on the Internet, the method comprising the steps of (a) displaying a template having a plurality of page layouts on the Internet; (b) displaying a template having a plurality of styles for the page layouts on the Internet; (c) after selection by a user of the page layout and style, displaying the selected combination of the page layout and style for forming a selected photo page on the Internet; and (d) inserting one or more images that are selected by the user into the selected photo page.

The above and other objects of the present invention will become more apparent when taken in conjunction with the following description and drawings wherein identical reference numerals have been used, where possible, to designate identical elements that are common to the figures.

Advantageous Effect of the Invention

The present invention has the following the advantage of permitting novice users to include images on web pages in a user-friendly aesthetically pleasing manner. Still further, the present invention also automatically resizes the images and includes a template photo page illustrating the page layout for ease of use in creating the web page.

### BRIEF DESCRIPTION OF THE DRAWINGS

FIG. 1 is a front view of a computer system for implementing the present invention,

FIGS. 2a-2f are illustrations of a photo page creation tool for inputting images on web pages; and

FIG. 3 is an illustration of a typical web page of the present invention.

### DETAILED DESCRIPTION OF THE INVENTION

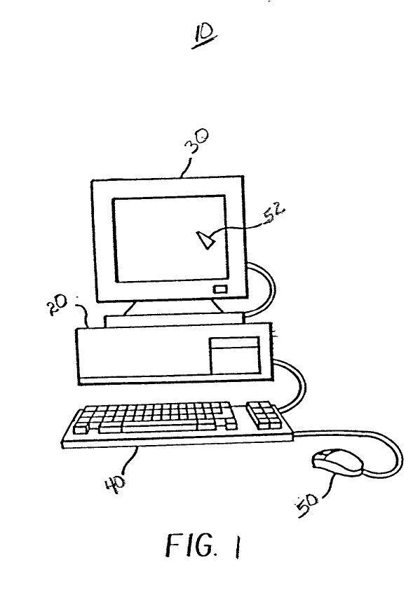

Referring to FIG. 1, there is illustrated a computer system 10 for implementing the present invention. Although the computer system 10 is shown for the purpose of illustrating a preferred embodiment, the present invention is not limited to the computer system 10 shown, but may be used on any electronic processing system. The computer system 10 includes a microprocessor-based unit 20 for receiving and processing software programs and for performing other processing functions. A display 30 is electrically connected to the microprocessor-based unit 20 for displaying user-related information associated with the software. A keyboard 40 is also connected to the microprocessor based unit 20 for permitting a user to input information to the software. As an alternative to using the keyboard 40 for input, a mouse 50 may be used for moving a selector 52 on the display 30 and for selecting an item on which the selector 52 overlays, as is well known in the art.

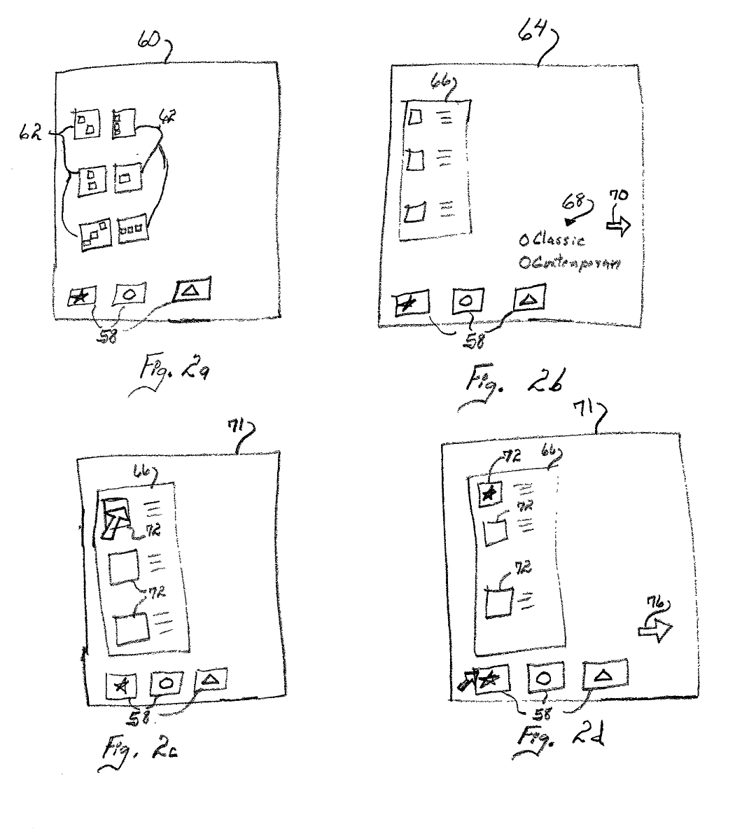

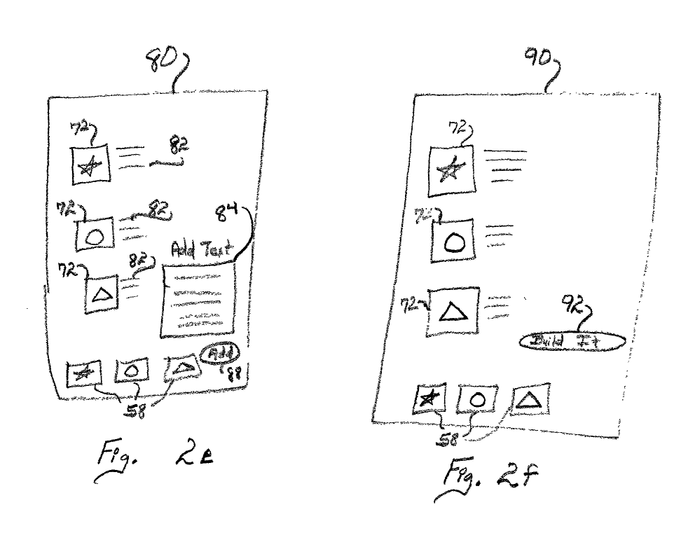

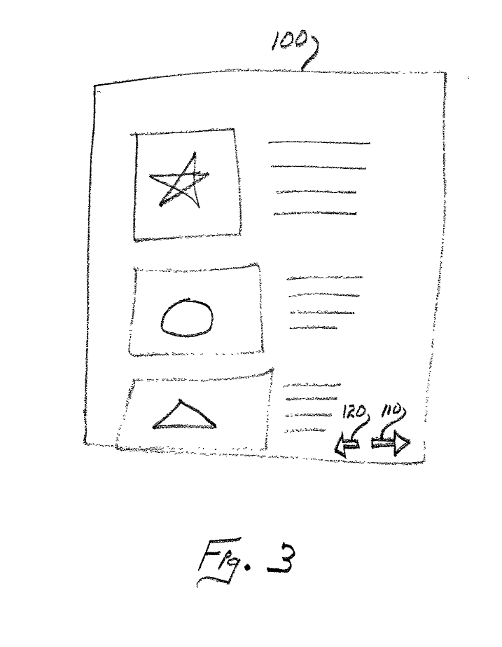

Referring to FIG. 2a-2f, the present invention is shown for creating the photo pages on the Internet. First the user would, using a web browser, travel to the location of the authoring tool on the web. The user uploads their images 58 to the initial web page 60, which are input into a bottom portion of the initial web page 60. The initial web page 60 also includes a plurality of thumbnail images 62 containing photo page layouts that are available to the user. Each layout presents a different arrangement of pictures and text block, each optimized for a different use or need, such as a gallery display of pictures or photo-based storytelling. The user selects the desired layout by clicking thereon and the second web page 64, as shown in FIG. 2b, is displayed to user. This web page 64 displays the selected page layout 66 in thumbnail image format and also displays various styles 68 available for the chosen layout. For example, the user may select “classic”, or the user may select “contemporary”. The style selection defines the color pallet, the page backgrounds, the font style, and the photo-embellishments (such as the picture frames) that will be used in conjunction with the layout. After selecting the desired style, the arrow icon 70 is selected.

Referring to FIGS. 2c and 2d, there is shown the same web page 71 at progressive points in time, which web page is displayed as a result of the final selection of the desired style. In regard to the photo paging process, the user then inputs the images into one of the locations 72 by clicking on one of the plurality of image locations 72 (FIG. 2c) and then clicking on the image 58 to be input into that location (FIG. 2d). This process is repeated for inputting each of the images 58 into their desired location. After completing this, the user clicks the arrow icon 76.

Referring to FIG. 2e, the user is then shown a web page 80 having the plurality of images inserted into the locations 72 and a blank portion 82 adjacent each image into which text can be inserted. In this regard, the user clicks on the blank portion of interest 72 and then types the particular text into the “add text” section 84. After completing writing the text, the user clicks on the add icon 88, and the written text is inserted into the blank portion 82 of interest. This process is then repeated for all of the text sections. After entering the last text into the blank portion 82, another web page 90 is automatically displayed as shown in FIG. 2f.

In this regard, the user is shown the web page 90 displaying a preview of the photo page. The user then clicks on the build it icon 92 for creating the final one or more photo pages.

Referring to FIG. 3, there is shown a typical photo page 100 having the inserted images and text. According to the number of inserted images and associated text, a forward icon 110 is positioned on a bottom portion of the photo page for displaying the next photo page, if any. A back icon 120 is also positioned on the bottom portion for scrolling backwards through the photo pages.

The invention has been described with reference to a preferred embodiment. However, it will be appreciated that variations and modifications can be effected by a person of ordinary skill in the art without departing from the scope of the invention.

| | |
|---|---|
| 10 | computer system |
| 20 | CPU |
| 30 | monitor |
| 40 | keyboard |
| 50 | mouse |
| 52 | GUI |
| 58 | uploaded images |
| 60 | web page |
| 62 | page layouts |
| 64 | web page |
| 66 | selected page layout |
| 68 | styles |
| 70 | icon |
| 71 | web page |
| 72 | image locations |
| 80 | web page |
| 82 | text locations |
| 84 | text section |
| 88 | add icon |
| 90 | web page |
| 92 | build it icon |
| 100 | photo page |
| 110 | forward icon |
| 120 | back icon |

1. A method for displaying photo pages on the Internet, the method comprising the steps of:
(a) displaying a template having a plurality of page layouts on the Internet;
(b) displaying a template having a plurality of styles for the page layouts on the Internet;
(c) after selection by a user of the page layout and style, displaying the selected combination of the page layout and style for forming a selected photo page on the Internet; and
(d) inserting one or more images that are selected by the user into the selected photo page.

2. The method as in claim 1 further comprising the step of (e) inserting text that is input by the user and that is associated with one or more of the images onto the photo page.

3. The method as in claim 2 further comprising the step of (f) displaying a preview photo page of steps (a) through (e) on the Internet.

4. The method as in claim 1, wherein step (a) includes displaying thumbnail images of the page layouts.

5. A method for displaying photo pages on the Internet, the method comprising the steps of:
(a) displaying a template having a plurality of page layouts on the Internet;
(b) after selection by a user of the page layout, displaying the selected page layout for forming a selected photo page on the Internet; and
(c) inserting one or more images that are selected by the user into the selected photo page.

6. The method as in claim 5 further comprising the step of (d) inserting text that is input by the user and that is associated with one or more of the images onto the photo page.

7. The method as in claim 6 further comprising the step of (e) displaying a preview photo page of steps (a) through (d) on the Internet.

8. A method for displaying photo pages on the Internet, the method comprising the steps of:
(a) displaying a template having a plurality of styles for a page layout on the Internet;
(b) after selection by a user of the style, displaying the selected style for forming a selected photo page on the Internet; and
(c) inserting one or more images that are selected by the user into the selected photo page.

9. The method as in claim 8 further comprising the step of (d) inserting text that is input by the user and that is associated with one or more of the images onto the photo page.

10. The method as in claim 9 further comprising the step of (e) displaying a preview photo page of steps (a) through (d) on the Internet.
